(19) United States
(12) Patent Application Publication
(10) Pub. No.: US 2021/0107793 A1
(43) Pub. Date: Apr. 15, 2021

(54) Manufacture of Graphene and Graphene Composition of Matte

(71) Applicants: Brian J. Edwards, Knoxville, TN (US); Nicholas Ciparro, Knoxville, TN (US)

(72) Inventors: Brian J. Edwards, Knoxville, TN (US); Nicholas Ciparro, Knoxville, TN (US)

(73) Assignee: CELTIG, LLC, Knoxville, TN (US)

(21) Appl. No.: 15/095,729

(22) Filed: Apr. 11, 2016

(51) Int. Cl. C01B 32/192

(52) U.S. Cl. CPC C01B 32/192; C01P 2004/04; C01P 2004/03; C01P 2004/64

(57) ABSTRACT

The specification discloses methods and associated equipment in a system of machine elements for industrial scale manufacture of graphene from graphite through use of a liquid medium comprising a non-toxic, water-soluble aliphatic solvent and water, together with graphite particulate dispersed therein. The medium promotes dispersion of the graphite particles and pre-conditions the graphitic material to delamination as ultra-high velocity flow streams of the dispersion are conducted through disintegration zones under powerfully turbulent flow conditions and associated vorticity with intense shear forces imposed on the particles over extended dwell times to effectively exfoliate and comminute the graphitic material, providing substantially complete conversion of the same to stably dispersed mono or few layer graphene particles in the resulting graphenic dispersion. Embodiments of the invention enable extraordinary yields of high quality graphene approaching 98 wt. %, along with unprecedented graphene mass production rates on the order of 1,000 kg/day or more. The liquid medium is not consumed in the process, and is readily separable from the graphene product for reuse, making the process highly efficient.

### BACKGROUND

### 1. Technical Field

The present disclosure relates in general to the production of graphene particulate material and, in particular, to a system for industrial scale production of consistently high quality graphene that significantly broadens opportunities for beneficial use of this extraordinary material in a wide range of applications such as, for example, in the manufacture of solar panels, electrodes, optical films, coatings, nanocomposite materials, batteries, fuel cells, and many more applications and uses yet to be determined.

### 2. Description of the Related Art

Graphene exhibits many remarkably beneficial electrical, mechanical, optical, and other properties that make it a potentially world-changing material over the coming years. Recognition of the commercial importance of graphene has fueled a dramatic increase in efforts to develop new methods for manufacturing consistently high quality graphene that positively address existing and future expected demand for this material—processes that are relatively simple and are capable of making customizable, high quality graphene in high yields and in an economical manner, with little or no known commercially/industrially significant drawbacks or negative environmentally consequences; and which avoid use of hazardous or toxic agents, which use recyclable materials, and which are relatively energy efficient with a minimal carbon footprint. In this regard, many involved in the search for better ways to make and process graphene appear to do so from the perspective that effective graphenization processes require some measure to effectively protect against what is believed to be the inherent tendency of graphene to revert to graphite during graphenization processes, considered to be a lower energy and/or more stable allotrope of carbon. One conventional approach for addressing the regressive tendencies of graphene is to incorporate oxidation/reduction steps into processing methodologies in order to, among other things, form an oxide of the graphitic carbon in the early stages of the process and then, in the later stages, to convert the material to a reduced form. This is believed to inhibit regression of graphenic particles into graphite as the graphenization process is concluding. This assumption and related aspects of conventional thinking has led many to incorporate additional, relatively complex steps into graphenization processes, steps that require use of hazardous, costly oxidation/reduction agents that are not recyclable or are significantly degraded in use, that often pose significant dangers and risks, and which also tend to cause “defects” in the product and other deleterious effects that materially degrade the quality of the product. It is believed these and other assumptions and beliefs held by those attempting to develop new graphenization technologies are flawed, and that they are hindering development of facile processes and technologies for making high quality graphene on an industrial scale.

For the above and other reasons, a cost-effective method for making industrially significant quantities of high quality graphene on the order of tons per day or more continues to elude workers in this area. With the advent of such a method, it is believed that commercial demand for bulk quantities of graphene will quickly expand and intensify. As industry segments learn of the ready availability of commercially significant quantities of this remarkable material and of the many unparalleled benefits inclusion of quality graphene will bring to a wide range of applications, production of the material is expected to escalate into a large scale, global industry, creating thousands of new jobs, generating billions of dollars of new industrial activity, and broadly advancing the art of material science as it relates to beneficial commercial utilization of carbonaceous allotropes.

### BRIEF SUMMARY

With regard to the above and other needs, objects, and attributes, the present invention provides, in one aspect, a method (a/k/a “process”) for making graphene which, in one preferred embodiment, comprises mixing graphite particles with a liquid medium comprising liquid water and a water-soluble aliphatic solvent to cause formation of a liquid graphitic dispersion. The liquid medium is selected to effectively wet and therefore enable better dispersion of graphite particles therein and to condition graphite particles in the graphitic dispersion to promote delamination thereof by enhancing transmission of delaminative forces onto and into interstices of the particles. Mixtures of predominately acetone and water are most preferred for these purposes; however, it is believed mixtures of water along with acetone and ethanol, or with ethanol in lieu of acetone, and/or with ethanol and methanol, all with a minor component of water, may also be used effectively in carrying out the process.

The liquid graphitic dispersion is conducted along an overall flow directional axis and flow streams thereof are then directed at relatively high flow velocities into and through one or more disintegration or vorticity eddy recirculation zones and associated other tortuous paths defined by structure therein so as to cause the flow streams moving through said zones and along said paths to undergo sharply disruptive changes in flow direction. These abrupt changes in direction help to induce multiple associated and dissociated vortical flow streams moving at ultra-high Reynolds numbers in excess of 10⁶ and local shear rates in excess of 10⁴ s⁻¹ in order to establish intensely turbulent, ultra-high shear flow conditions and associated ultra-high particle vorticities under which the conditioned graphite particles are subjected to powerfully concentrated, shear-induced interpenetrating delamination forces, together with high impact, interparticle and other collisions and associated particle comminution to cause exfoliative conversion of a substantial portion of graphitic particles to graphenic particles in a graphenized or “graphenic” liquid dispersion.

The resulting graphenic dispersion product includes the liquid medium and a carbonaceous particulate product advantageously comprising at least about 80% (dry weight basis) graphene particulates having a single layer or 15 or fewer layers dispersed therein, with an average layer number of approximately 5. The graphenic dispersion is treated to separate and recover the carbonaceous particulate product from the liquid medium.

In further preferred embodiments of the invention, the process is conducted on an essentially continuous basis. And whether conducted in a batch or continuous mode, it is especially preferred, and a feature of the invention, that little if any of the liquid medium is consumed in the process and that substantially the entire liquid medium from which the carbonaceous product is readily recovered may be recycled for use in providing liquid medium for mixing with fresh graphite for the continuation of the process.

Embodiments of the invention provide methods and equipment for the conversion, via primarily mechanical exfoliation, of graphite particles (referred to herein, at times, as “graphenic material”) to substantially mono or relatively few layer graphene particles (15 or fewer, preferably 10 or fewer, and most preferably 5 or fewer layers) with unprecedented yields of graphenic material approaching 98 wt. %, and in commercially significant bulk production levels on the order of tons per day. The particles that comprise the graphene product exhibit uniquely beneficial properties and characteristics, including exceptional dimensional/structural uniformity in the nature of relatively narrow ranges of particle dimensions and layer structure (i.e., “layerosity”) that can be adjusted by varying certain conditions and other aspects of the manufacturing process, thereby enhancing and expanding the already considerable array of potential commercial uses of graphene in the nanocomposite materials, fuel cell/battery, conductive coatings, films, packaging, laminate, structural, and many other known and yet to be discovered industries and applications.

Production of graphenic material in accordance with currently known embodiments of the invention may be accomplished by subjecting a graphitic dispersion comprising, among other things, a new liquid medium for dispersing and pre-conditioning graphite particles, to the action of equipment within a system of machine elements configured and arranged to cause flow streams of the graphitic dispersion to be conducted at relatively high flow velocity through one or more tortuous paths defined by structure in one or more disintegration zones and to undergo sharply disruptive changes in direction therein and to induce strongly vortical flow regimens at ultra-high Reynolds numbers in excess of 10⁶ and local shear rates in excess of 10⁴ s⁻¹ in order to establish intensely turbulent, high shear flow conditions and associated ultra-high eddy recirculation vorticity regions under which the pre-conditioned graphite particles are subjected to powerfully concentrated, shear-induced interpenetrating delamination forces, together with high impact, interparticle and other collisions and associated particle comminution. In preferred embodiments, these and other beneficial effects are brought about by traversal of the graphitic dispersion through multiple disintegration zones arranged in close succession to one another in order to militate against potential negative effects of short periods of unconstrained flow of the dispersion between axially spaced-apart, adjacent disintegration zones such as, for example, any untoward dissipation of energy in the highly turbulent, vortical flow of the dispersion and/or any associated remittance of delaminated particulate material, and attendant loss of graphenization progress achieved in the immediately preceding zone. Accordingly, one feature of the present invention is arrangement of multiple disintegration zones in relatively close axial adjacency in order to provide effectively extended dwell or residence times of particles in the dispersion undergoing graphenization under the energetically intense turbulence and eddy vorticity provided by the inventive process and associated system. These extended particle dwell times are preferably in the neighborhood of at least a total of about 2000 seconds, most preferably at least about 2500 seconds, to thereby promote virtually complete graphenization of the graphitic dispersion, that is, conversion of the same to an ultra-fine dispersion of mono or relatively few layer graphene particles at remarkably high conversion rates approaching or exceeding 98 wt. %, with the graphene particles recoverable therefrom as a substantially dry powder exhibiting the novel and propitious graphenic compositional attributes according to the invention.

Another feature of the invention is the division of the graphitic dispersion into multiple, substantially parallel flow streams by means of disposition of radially adjacent disintegration zones so as to direct flow streams exiting the tortuous paths in the zones generally spirally in relation to the overall flow directional axis so as to induce at least some of the resulting vortices to exhibit velocity vectors disposed radially in relation to the overall flow directional axis.

Other known benefits of the invention include, but are not limited to, the substantial avoidance of any need for oxidation or reduction of the carbonaceous particles in connection with graphenization thereof, a somewhat vexing aspect of conventional regimens that the present inventors have determined to be unnecessary. Accordingly, one additional feature of the present invention is the ability to dispense with certain measures or treatments such as formation of oxidized intermediate graphitic material and associated later reduction of the same as used in prior methods to inhibit reformation of graphite.

In accordance with one preferred embodiment, the process includes an initial mixing stage wherein graphite, in particulate form, from a suitable source such as, for example, and not by way of limitation, micronized natural flake graphitic material, is suspended in a liquid dispersing medium comprising a substantially non-oxidizing liquid mixture comprising water and a water-soluble aliphatic solvent selected from the group consisting of water-miscible lower ketones, aldehydes, esters, and alcohols with 6 or less carbon atoms, and mixtures of one or more thereof, preferably a liquid dispersing medium comprising a substantially non-oxidizing liquid mixture of water and a water-soluble aliphatic solvent selected from the group consisting of lower ketones and alcohols with 6 or less carbon atoms, and mixtures of one or more thereof, and most preferably a liquid dispersing medium comprising a liquid mixture of water and a water-soluble aliphatic solvent selected from the group consisting of acetone and ethanol and mixtures thereof. An especially preferred liquid dispersing medium is a liquid mixture of water and acetone. Particularly preferred are liquid mixtures of acetone and water exhibiting a surface tension of from about 40 mN/m² to about 70 mN/m², to which may also be added modifiers such as ascorbic acid and corrosion or oxidation inhibitors such as hexamine, hydrazine, and phenylenediamine, together with other additives, as needed, to enhance or boost certain aspects of the dispersing medium.

In a broad sense, the dispersing medium may comprise liquid water and liquid acetone in a volume ratio of from about 10:90 to about 90:10. Particularly preferred are mixtures comprising water and acetone in volume ratios ranging of 10:90 to 40:60, with the latter being most preferred; however, it is believed that other mixtures of water and acetone may be used that exhibit surface tensions appropriately compatible with the surface energies of the concentration of graphite and graphene to be dispersed and otherwise acted on by the dispersing medium in the force environment of the process. Most preferred are liquid dispersing mediums comprising about 15% (vol.) water and about 85% (vol.) acetone.

According to one preferred embodiment of the invention, graphite particles are dispersed in a liquid dispersing medium comprising a mixture of liquid water and acetone at a graphite concentration of from about 0.01 to about 10.0 g/l, preferably from about 0.025 to about 5.0 g/l, and most preferably at a concentration of about 3.0 g/l. The graphite preferably has a particle size ranging from about 0.1 micron to about 10 microns, and most preferably from about 0.5 microns to about 5 microns, with a particle size of about 1.5 microns being especially preferred.

However, it is to be noted that one object of the invention is to maximize the throughput or daily production capacity of the process for a given setting, and one factor in this is believed to be using the highest feasible concentration of graphite particles in the graphitic dispersion that can be effectively treated in the embodiment being employed. Accordingly, it is believed the most preferred concentrations of graphitic material are actually those that are the highest concentrations that can be processed under the processing conditions and parameters according to the invention, while still attaining a commercially acceptable high yield of high quality graphenic material of at least about 80% (dry weight of graphenic particles). One factor believed to influence the throughput rate is, of course, the size of the equipment and technical and material feasibility limitations of the same, and the maximum liquid mass flow rates that may reasonably be conveyed through very large size equipment under the conditions used in caring out the process. Other factors include the nature and composition of the dispersion medium, whereupon the most preferred concentration is also the highest concentration currently believed to be successfully treatable using the preferred acetone/water mixtures to successfully disperse and promote graphenization of graphitic dispersions containing the maximum feasible concentrations of graphite particles.

It is a feature of the invention that no oxidizing, intercalation, or other pretreatment step is believed to be needed, inasmuch as the exfoliation process of the present invention is substantially completely mechanical in nature and is able to successfully produce large quantities of high quality graphenic material without the need to employ any toxically hazardous chemicals and associated complications or potentially fractious reactions. Another feature of the invention is that the graphite particulate is effectively conditioned for enhancement of the delamination/exfoliation thereof by the surface-to-surface interaction of the liquid dispersing medium.

Once thoroughly mixed with the liquid dispersing medium, such as by standard industry mixing technology for at least about 10 minutes, preferably for at least about 15 minutes, and at a temperature of from about 15° C. to about 35° C., the liquid graphitic mixture is conveyed on a substantially continuous basis (in the continuous embodiments), as by use of a pump under an industrially common pressure head and at a flow rate that may range from about 0.05 l/s to about 5.0 l/s, into and through the initial stage of either of the continuously operable exfoliator units (or exfoliated via high-shear mixing in the case of the batch process), in which the flow velocity and the structure of the apparatus is selected to cause the medium containing the liquid graphitic dispersion to be directed through one or more disintegration zones, preferably in succession, wherein the dispersion is subjected to vigorously turbulent flow conditions at very high Reynolds Numbers and ultra-high local shear forces, thereby inducing relatively intense delamination forces on the graphite particles and relatively high speed interparticle, intramedium, and particle/structure collisions and associated comminution.

The combination of forces generated on the material in accordance with the invention induces mechanical exfoliation of the graphite particles into graphenic nanoparticles, nanoplatelets, and/or flakes in dimensional configurations ranging from about 50 nm to tens of microns in planar dimension with thicknesses of from about one to about 15 layers, with a preferred average particle layer number of about 3-6, each layer believed to have a thickness of about 335 picometers. The resulting liquid dispersion of graphene nanoparticles (graphenic dispersion) is conducted to a filtration/drying unit, wherein the graphene particles are separated from the solvent, which is recycled to the initial mixing stage.

Again, the process does not require and, in fact, demonstrates the lack of any need for any oxidizing agents, surfactants, environmentally harmful chemicals, elevated temperatures, intercalating agent, or explosive materials. Furthermore, the process does not require centrifugation or sonication, which are two common techniques used to exfoliate graphitic material and other layered crystalline materials. The product of this process is essentially defect-free graphene, depending on the quality of the starting graphitic material; i.e., due to the type of physical (as opposed to chemical) exfoliation mechanism used in the claimed processes, no additional defects are believed to be introduced beyond those already existing in the starting material. Using a high quality natural flake graphite results in essentially defect-free product. Conversion yield via exfoliation of graphitic starting material into graphene lies within the range of 80-98 wt. % or better, depending on the operating parameters of the process and the desired physical properties of the final product.

Evidence is provided below from several analytical techniques to demonstrate the quality of the graphene produced by the new process. Also provided below as one embodiment of the application of the graphene material produced via the processes summarized above is a method of producing electrically conductive organic liquids via the suspension of the graphene nanoparticles produced above in organic solvents within specific ranges of concentrations.

The above and other features and aspects of embodiments of the present invention will now be illustrated in greater detail in the following description, considered in conjunction with the accompanying drawing figures, in which:

### BRIEF DESCRIPTION OF THE FIGURES

FIG. 1 is a general schematic diagram of the continuous process, including the mixing stage, exfoliation stage, and filtration/drying stage.

FIG. 2 is a snapshot of graphene dispersed in (left to right) pure water, pure acetone, and a 5:1 (by volume) acetone and water solution at a concentration of 3.0 g/l.

FIG. 3 is a simple, conceptual schematic diagram of the so-called “vorticity-shear exfoliator” unit.

FIG. 4 is a detailed design of one embodiment of the jet-turbine impellers used in the vorticity-shear exfoliator process.

FIG. 5 is a detailed design drawing of one particular manifestation of one stage of the vorticity-shear exfoliator unit.

FIG. 6 is a simple, conceptual schematic diagram of the so-called “Taylor vortex shear exfoliator” unit.

FIG. 7 is a detailed design of the Taylor vortex shear exfoliator unit.

FIG. 8 is a sample Raman spectrum of graphene particles produced using the presently disclosed process. The horizontal axis is in units of cm⁻¹ and the vertical axis is the measured signal intensity.

FIG. 9 is a snapshot of a typical SEM image where the scale indicated in the bottom left corner is 1 micron.

FIGS. 10 A-F displays AFM traces of typical graphene platelets of approximately 0.3 to 2 microns in planar dimension.

FIGS. 11 A-B displays TEM images and corresponding diffraction patterns of single and few layer graphene nanoflakes of planar dimensions on the order of 0.1 to 2 microns on a lacy carbon grid.

FIGS. 12 A-B displays bimodal particle size distributions of graphene nanoflakes produced via the claimed processes.

FIGS. 13 A-B displays bimodal layer number distributions of graphene nanoflakes produced via the claimed processes.

FIG. 14 is a plot of conductivity properties (resistivity) of dispersions of graphene particles produced using the presently disclosed process in a variety of organic liquids.

### DETAILED DESCRIPTION

Unless otherwise noted, all terms (including technical and scientific) used herein will have the same meaning as is usually understood by someone of common skill in the art to which these inventions apply. It is also understood that any terms used herein should be interpreted as having a meaning which is consistent with standard meaning in the context of the relevant art and will not be interpreted in an idealized or overly formal sense unless defined within this document. The use of any and all examples, or exemplary language (such as “for example” or “e.g.”), is intended for purposes of illustration only, and does not imply any limitation on the scope of the inventions unless otherwise stated. Furthermore, no language within this document should be construed as implying that any non-claimed element of the inventions is essential to the practice of the inventions or is in any way related to non-standard practices within the art. The inventions disclosed herein contain numerous embodiments, the majority of which will not be described herein but will be recognized as such by a practitioner of ordinary skill of the art. Specific embodiments mentioned are used merely as illustrations of the numerous possible embodiments of the invention, and should not be construed as limitations on the inventions.

Hereinafter, the inventions presented in this disclosure will be described in detail with reference to the accompanying figures.

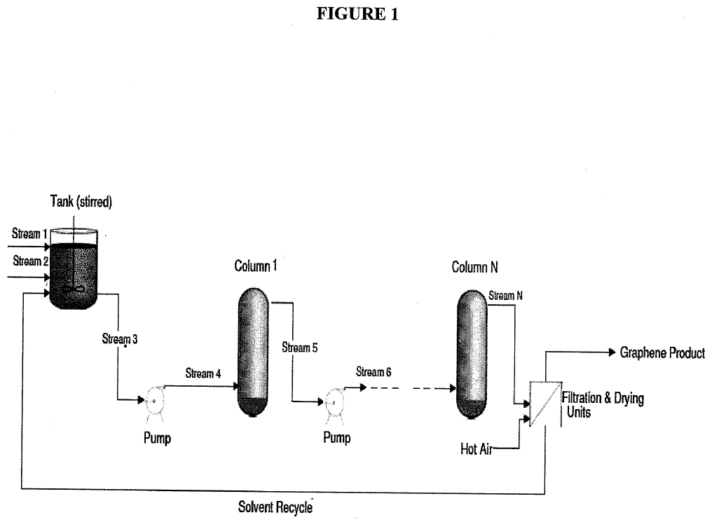

An embodiment of the continuous process is depicted generally in the schematic diagram of FIG. 1. Streams 1 and 2, representing solvent (e.g., acetone plus water) and graphite, enter the mixer wherein the desired concentration of suspension is prepared via mechanical stirring under standard operating conditions in the industry. In one embodiment of the process, e.g., graphite is mixed with the solvent at a concentration of 3 g/l. The resulting suspension enters the exfoliator unit, denoted as “Column 1” in the flow chart schematic, via streams 3 and 4. This unit is either one of two exfoliators to be described below. Throughput into and exiting the exfoliator unit, as well as the overall process, is set at a predetermined volumetric flow rate so as to produce the desired rate of graphene production. The specific embodiment of flow rate depends also on the necessary retention time within the unit, as the degree of exfoliation strongly depends on this quantity, as well as the relative concentrations of the solvent mixture, described below. The exfoliator units act on the graphite particles via mechanically inducing turbulent shearing flows of Reynolds number in excess of 10⁶ and generate local shear rates in excess of 10⁴. These high shear forces are necessary to overcome the binding van der Waals forces that hold the basal planes of the graphitic material together. The retention time/flow rate of the process depends critically on the height of the exfoliator column. For industrial scale graphene production, columns ranging generally from 5-40 meters may be required, depending on the desired rate of production. However, multiple exfoliator units can also be used to reduce the overall size of each unit, with the effluent from each unit being sent (via streams 5-N) to the subsequent unit in serial progression without affecting the quality of the product to achieve the total column height. With either exfoliator unit, input graphite to output graphene yields are on the order of 80-95%, dependent on the quality of the starting material and the process parameters. Effluent from the final exfoliator column is then sent to a filtration/drying unit(s), such as a filter press or spray drier, via stream N. Product is removed from the filtration/drying unit(s), and solvent is recycled to the mixing tank. Graphene nanoparticles and flakes produced via these processes range in size from approximately 50 nm to tens of microns.

The associated physics of the exfoliators and exfoliating mechanism is as follows. Graphite is composed of many thin layers of carbon atoms. Carbon is a hydrophobic material, and this hydrophobic nature greatly inhibits aqueous-based exfoliation of graphite to graphene since it is difficult to transfer the shear stress onto the graphite surface and because only small concentrations of graphite can be suspended in relatively large volumes of water. For this reason, most exfoliation processes involve aqueous-based surfactants, which help to suspend the graphite, or organic solvents which approximately match the surface energy of the graphitic material. Furthermore, any graphene produced by the process must be prohibited from aggregating back into a layered graphitic-like structure while in dispersed in a solvent, which is an energetically favorable state. Most processes use surfactants to prohibit the aggregation of the graphene particles since these coat the graphene particles, preventing them from contacting each other; this creates an additional problem, that of ultimately removing the surfactant to obtain a pure product. Another mechanism for achieving this separation is to remove the energetic tendency of the graphene particles to aggregate by matching the surface energy of an organic solvent to that of the graphene, thereby effectively masking the graphene particles from each other in an energetic sense. However, a consistently vexing problem when using organic solvents for this purpose is that most solvents, particular the least expensive and most benign, typically have surface energies far below that of graphene. In the process described in this proposal, neither surfactants nor pure organic solvents are used to isolate the graphene particles from each other. Instead, a mixture of an organic liquid, e.g., acetone and water, is used in such a ratio that the surface energy of the resulting solvent is equal to that of the graphene/graphitic material. Since water has a surface energy in excess of graphite/graphene (about 73 mJ/m³ vs. a typical literature value of 68 mJ/m³), and acetone has a surface energy below that of graphene (about 25 mJ/m³), a solvent with the appropriate range of surface energy can be fine-tuned to match that of the graphite/graphene. This situation applies to many possible organic solvent/water mixtures, composed of compounds from the following groups: ketones, esters, ethers, alcohols, phenols, quinones, aldehydes acetates, carboxylic acids, and peroxides. The only prerequisite is that the organic liquid must be completely miscible with water, and any azeotropes thus formed are at the extreme ends of the relative concentration ranges necessary for exfoliation. Hence a process involving only a mixture of water and acetone is inexpensive, environmentally benign, nonreactive, chemically inert and easily adaptable to different situations by changing the relative ratio of, say, acetone and water. Furthermore, since the process involves no surfactant, the issue of surfactant removal is moot.

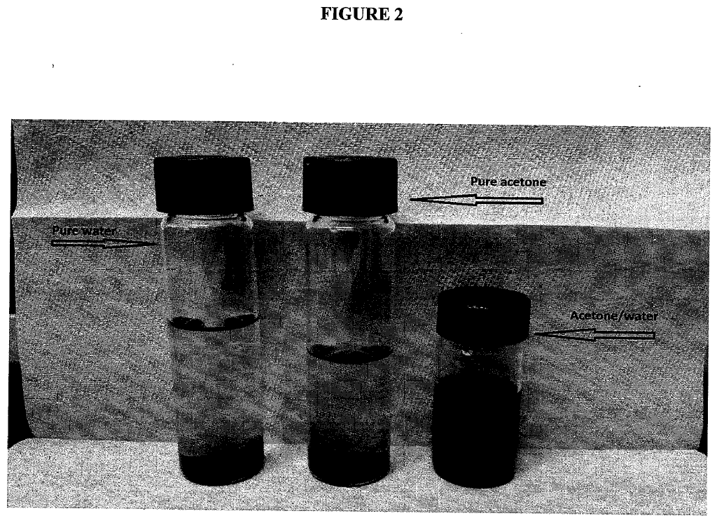

FIG. 2 illustrates by way of example the use of a mixture of an organic liquid with water to match the surface energy of the graphitic material. The two bottles on the left contain pure water and pure acetone, respectively, each mixed with 3.0 g/l of graphitic material. It is clearly evident in each case that the graphitic material has almost completely deposited on the bottom of the vials, a process which normally takes approximately 3 hours in pure acetone and about 1 hour in pure water. In the vial on the right, however, is the same concentration of graphitic material dispersed in a mixture of acetone and water at the ratio of 5:1 by (ideal) volume. In this case, the graphitic material remains suspended within the fluid indefinitely; this particular vial was photographed approximately 2 weeks after it was prepared.

In summary, the organic liquid/water exfoliating mixture has a three-fold purpose: to allow greater amounts of graphite (and ultimately graphene) to be suspended in a predetermined volume of solvent, to prevent aggregation of the graphene platelets produced by the process, and to allow for a transfer of shear stress from the water/acetone mixture to the surface of the graphite so that exfoliation can occur; i.e., the presence of the organic liquid allows for a more substantial contact between solvent (organic) molecules and the graphite surface, thereby allowing a greater dispersion capacity as well as providing a liquid film through which a higher shear stress can be transferred onto the graphite surface than in the case of a pure water solvent. Furthermore, there is an additional role that the organic liquid can play in the process, which is to interpenetrate the graphite to allow swelling and loosening of the graphite layers for easier exfoliation. This intercalating effect can aid the exfoliating process, but is ultimately not absolutely necessary to achieve a high yield of graphene from the process.

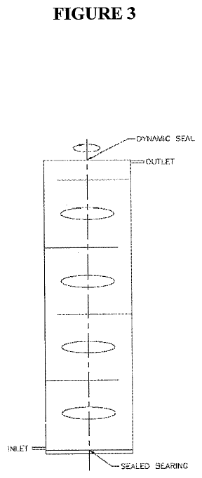

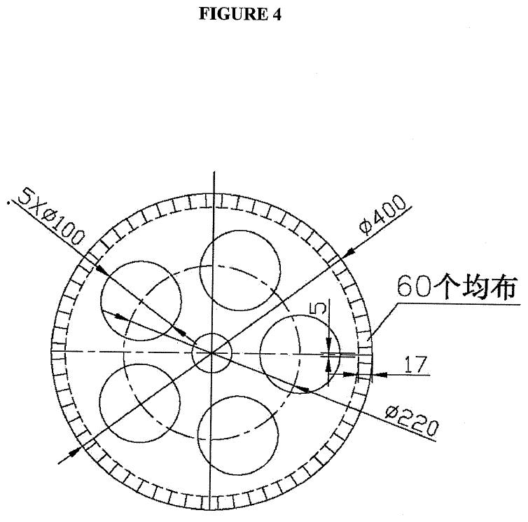

Two exfoliator units were designed for the continuous process described above. The first of these is called a “vorticity-shear exfoliator” unit, and is depicted in a conceptual sense in FIG. 3. The unit is divided into stages, with each stage being separated vertically from the previous stage through cross-baffled trays with inlet holes on one side with specific diameters predetermined from the desired volumetric flow rate of the graphite suspension. In one embodiment, for example, one stage is required for every 0.75 m of column height. The flow rate of the suspension through the unit is set based on the desired retention time within the unit, which is determined by the amount of time necessary to achieve a specified degree of graphite to graphene conversion. Each stage is stirred by one or more impellers, which are attached to a common shaft that spins the impellers at a rate of 1000-4000 rpm. In one embodiment of the process, jet-turbine impellers are used with 60 equally sized pitched blades set at an angle of 35 degrees relative to the plane of the impeller. One particular embodiment of a design of the jet-turbine impeller is shown in FIG. 4. The impeller plate contains five concentric holes cut into the plane to reduce its mass, and hence moment of inertia, and to let fluid circulate upward through the center of the impeller. This unit produces an overall Reynolds number within the unit stages in excess of 10⁶ and local values of the shear rate in excess of 10⁴ s⁻¹.

In many ultra-high shear mixing systems, a rotor-stator unit is used to produce the high shear rates necessary for adequate shearing. These units consist of an inner rotating assembly (the rotor) spinning rapidly within a stationary outer shell with a small gap of fluid between the two. Usually, these units are designed so that fluid is sucked into the rotor/stator through the bottom of the assemblage and ejected through holes in the wall of the stator. This geometry creates a strong shear force within the gap; however, the overall tank (i.e., outside the rotor-stator assemblage) is not subjected to the same ultra-high shear rates but is merely being stirred at a much lower Reynolds number and corresponding shear rates. Consequently, in an exfoliation process, only during the material's residence time within the rotor-stator (about 1 s per pass, on average) is it experiencing high shear forces. This greatly reduces the accumulation of shear upon the graphitic planes when exfoliating to graphene. Within the vorticity-shear exfoliator, the material is constantly subjected to ultra-high shear rates throughout the mixing volume, not just within the immediate neighborhood of the impeller. Hence the effective residence time of the material within the exfoliator is orders of magnitude greater than when using a rotor-stator assembly; i.e., the material throughout the tank is constantly subjected to ultra-high shear rates at all times. The fluid motion throughout the tank in the horizontal direction is dictated by the rotation of the impeller, whereas the fluid moves in the vertical direction by rising in the immediate vicinity of the rotating shaft/impeller and then recirculating downward along the walls of the tank, thus creating a highly complex flow field capable of generating the sustained, ultra-high shear forces necessary for exfoliation.

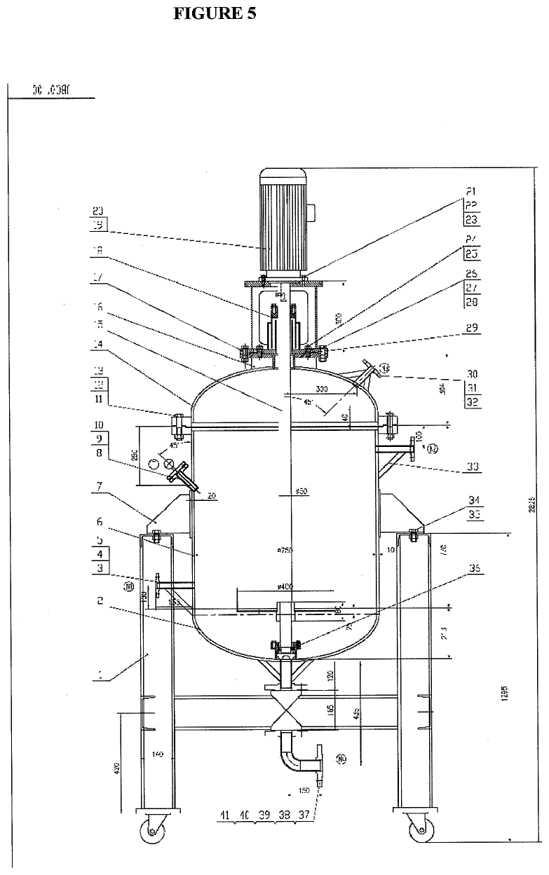

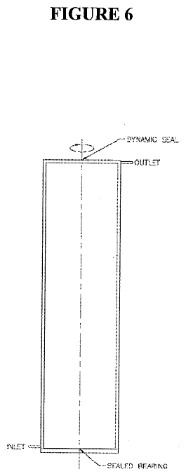

FIG. 5 presents a detailed design of one particular embodiment of the vorticity-shear exfoliator. The key design component is the ability to adapt the number of stages to the mass production rate of graphene required. In the design of FIG. 5, only a one-stage column is depicted. The inside of the tank is designed to accommodate four baffles of standard height and width in the industry to maximize the shear agitation within the tank. A single shaft anchors the impeller, which is rotated at rates in the range of 1000-4000 rpm. The shaft sits in a sealed bearing at the bottom of the tank for stability, and is sealed at the top with a dynamic seal around the shaft. The middle section of the schematic represents the column's (in this embodiment) single stage. The exfoliator is designed such that the cap can be removed, and multiple stages stacked on top of the first stage, each separated by a cross-flow baffle, as described above, and containing an additional impeller to shear the material within its volume. In this way, the mass production flow rate through the device can be increased while maintaining the necessary retention time of the fluid within the exfoliator. A maximum of five stages can be mounted in a single column, and then further stages can be added by feeding the effluent into additional columns, as depicted in the process of FIG. 1. In such a fashion, production rates of up to 1000 kg/day can ultimately be achieved.

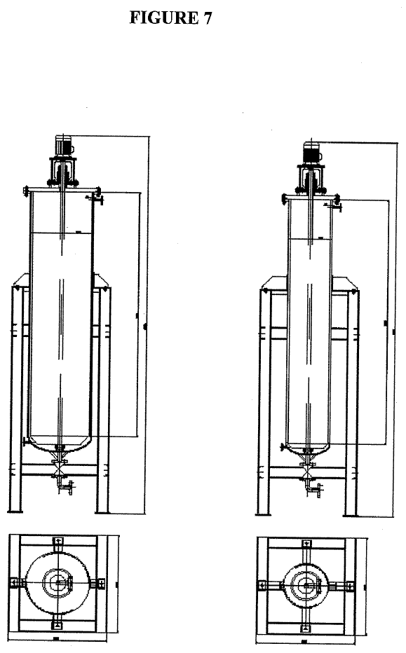

The second exfoliator unit designed for the process of FIG. 1 is illustrated conceptually in FIG. 6, and in detail for two particular embodiments in FIG. 7. This unit is called a “Taylor vortex shear exfoliator” unit, and it involves two concentric cylinders, the inner of which is spun at a rate of 1250-2500 rpm, thus generating Reynolds number within the annulus between the cylinders in excess of 10⁵ and local values of the shear rate well in excess of 10⁴ s⁻¹. The unit employs physical principles initially discovered by G. I. Taylor in the 1920's, who determined the conditions under which high-shear vorticity fields (i.e., so-called “Taylor vortices”) could be generated within the annulus between the two cylinders. The graphitic suspension flows into the unit at the bottom of the column, and subsequently experiences ultra-high shear forces as it passes upward through the column at a flow rate which is set to impart the desired retention time to the suspension. The column unit height can be adjusted based on the desired rate of graphene production. Multiple columns can be used, with the suspension passed serially from one unit to the next, as in the schematic of FIG. 1, in order to remain within applicable practical operating conditions for each column. Similarly to the vorticity-shear exfoliator, described above, the Taylor vortex shear exfoliator guarantees that the ultra-high shear rates are applied to the material continuously (i.e., for its entire residence time within the unit). A key advantage of this exfoliator, however, is the relatively small volume of fluid mixture that must be cycled through the device prior to recycling the solvent. Since the gap is narrow, the amount of solvent required to fill the unit to capacity is barely a tenth of that of the vorticity-shear exfoliator unit. The tradeoff, however, is a greater net energy consumption required by the Taylor vortex shear exfoliator.

Depending on the raw materials, i.e. the nature of the graphite, which can vary dramatically from source to source, and the process parameters, a wide range of graphene nanoplatelet materials can be produced in terms of distributions of flake size and layer number. Hence further discussion will focus on one embodiment of the above processes which has been fine-tuned to produce a distribution of particle size and layer number that is beneficial to at least two applications, as stated in the claims section below. This particular manifestation of graphene nanoflakes will be the focus of the following discussion; however, this is simply one embodiment of the graphene product that can be produced using the processes and equipment described above.

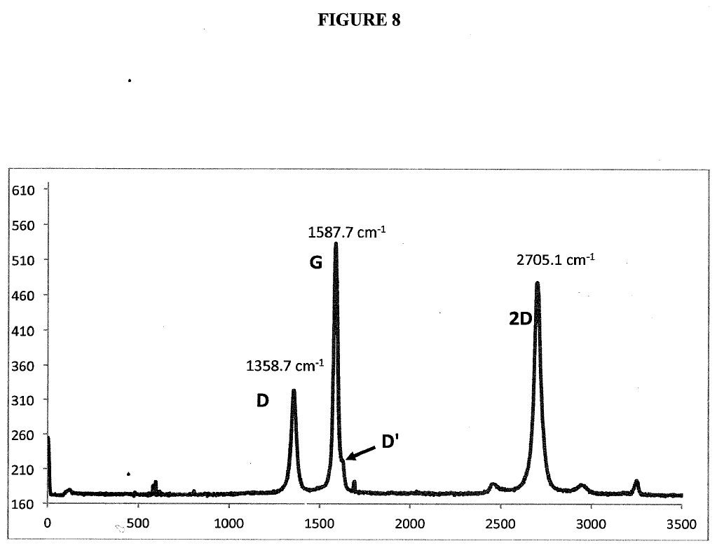

Graphene nanoplatelets and flakes produced via these processes as one particular embodiment, as described in the preceding paragraph, were subjected to various analytical procedures to determine their characteristics. A typical Raman spectrum, as an example, is displayed in FIG. 8. This spectrum displays peaks and positions that are known to be characteristic of multilayer graphene materials with a distribution of from 1-10 layers, as confirmed by Other methods of analyses. The ratios of the D/D′, G/D, and 2D/g peak intensities, and individual peak locations and shapes are well within the ranges established for the Raman spectra of defect-free, few-layer graphene.

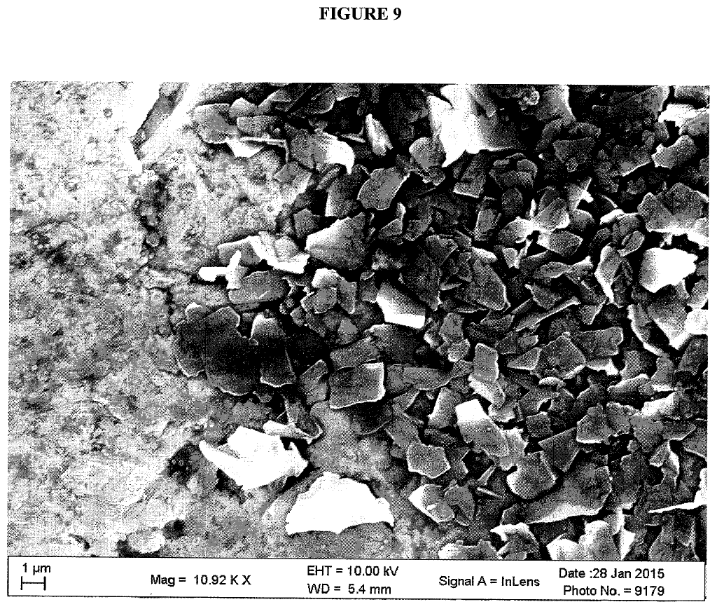

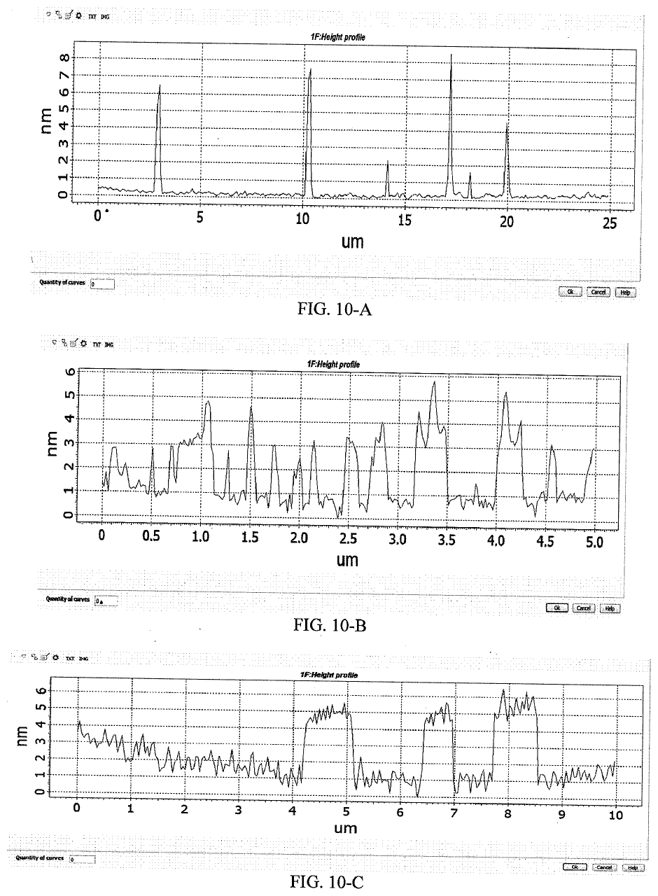

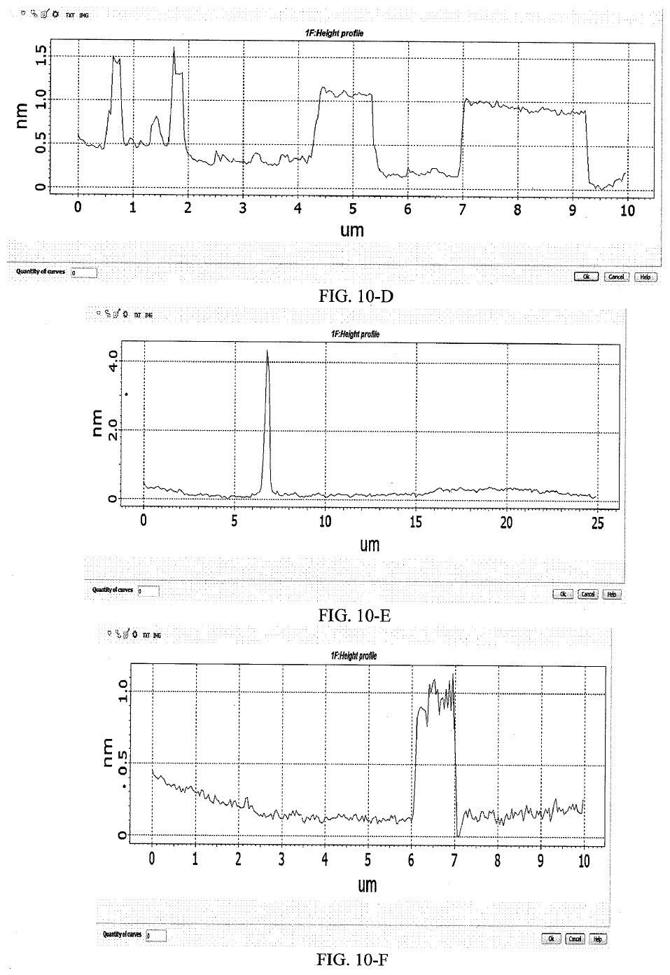

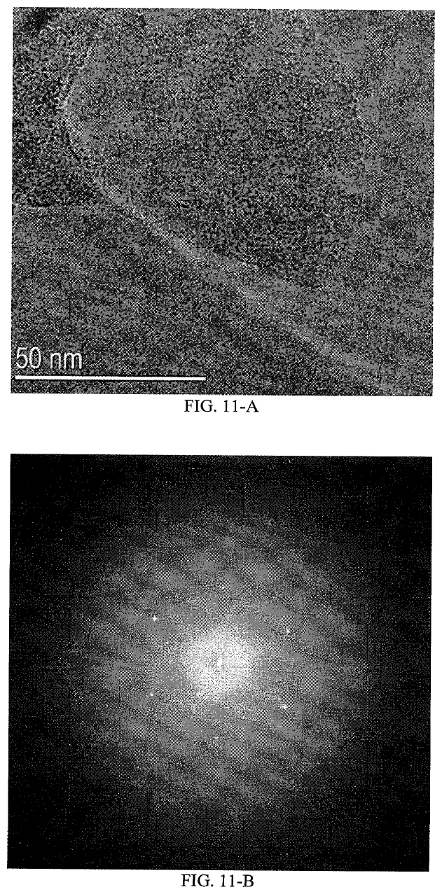

A typical Scanning Electron Microscope (SEM) image is displayed in FIG. 9 for a typical batch of product resulting from the processes described above. The material thus produced consists of narrow platelets ranging in size from approximately 0.1-5 microns, with an average thickness of 4 to 5 layers of graphene. Flakes composed of single layers and bilayers of graphene are clearly visible in the image. Images from SEM are useful for obtaining particle size distributions, as described below. Atomic Force Microscopy (AFM) and Transmission Electron Microscopy (TEM) are useful for obtaining information about not only particle size but layer number as well. FIGS. 10 A-F (occupies two pages) displays AFM height trace profiles of graphene flakes of approximately 300 nm to 2 microns in planar dimension. The peaks of these flakes range from roughly 0.5 to about 7 nm. According to literature sources, multiple layers of graphene stacked together result in physical dimensions of roughly 0.72 nm per stacked layer (layer thickness of about 1.85 Å×2 plus the interlayer spacing of about 3.5 Å), indicating that the nanoflakes shown in the AFM traces possess layer numbers in the range of 1-10. TEM images and the associated diffraction patterns of typical graphene nanoflakes are shown in FIGS. 11 A-B. These show clearly the presence of single and few layer graphene nanoplatelets of planar dimensions on the order of tens of nanometers to several microns.

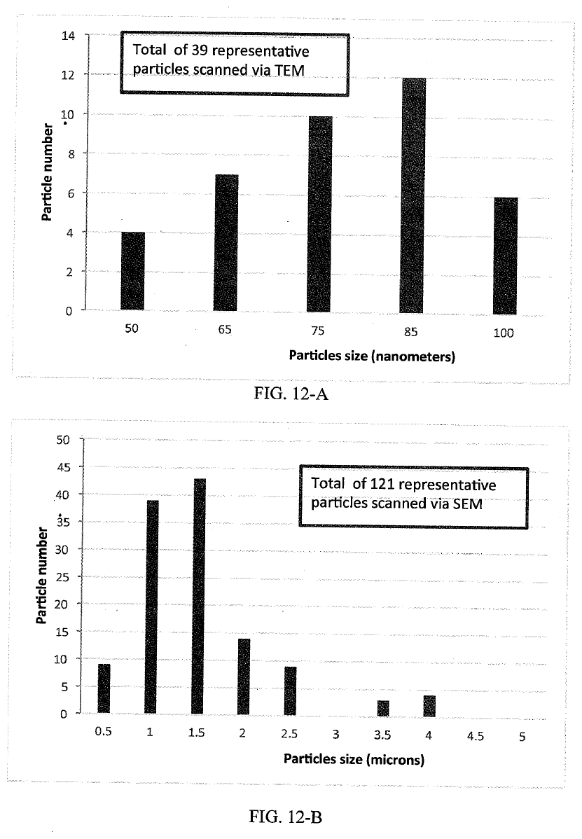

Distributions of particle size of the process product embodiment currently being described are shown in FIGS. 12 A-B. The overall distribution is bimodal, with peaks at 85 nm and 1.5 microns. The overall distribution is shown as two histograms because of the order of magnitude difference in particle size and particle number between the two flake size regimes. Note that these distributions were calculated separately, and that the stated numbers of particles at a given size range are representative of those examined in separate states. In other words, the two distributions are not directly comparable to each other, as there are in fact many more small-range particles than large range particles; however, the exact ratio is difficult to determine. We estimate that on a mass basis, approximately 8-9% of the total product mass lies in the small-scale range, and that the remainder consists of the larger particles. Basically, larger particles have a much larger mass, but there are many more small particles than large ones.

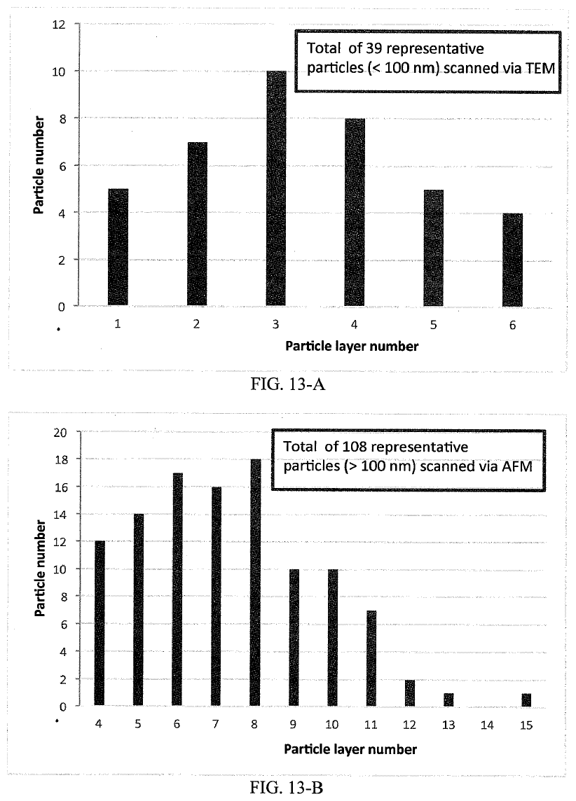

Distributions of particle layer number are presented in FIGS. 13 A-B. In the small particle regime, layer numbers range from 1 to 6 layers, with a distribution peak at 3 layers. In the large particle regime, layer numbers range from 4 to 12 layers (excluding single data point outliers), with a peak at 8 layers. These layer numbers fall within the category of graphitic materials commonly referred to as graphene. Geim and Novoselov, the original discoverers of graphene, stated in their 2007 Nature paper [Nature Materials, 6, 183, 2007], that graphene of 1-2 layers exhibited amazing physical properties, and graphene of 3-10 layers possessed excellent properties of a similar type of 1-2 layer graphene, but not to the same degree. They also inferred that any material with over 10 layers was effectively thin-layer graphite as far as physical properties were concerned. Hence the material produced via the processes claimed under this disclosure is shown to fall within the realm of what is generally referred to as ‘graphene’ in the relevant industries. The bimodal nature of the particle size and particle layer number distributions of this particular product makes it an excellent candidate material for nanocomposite and battery applications. The larger particles provide mechanical enhancements to potential nanocomposite applications, whereas the smaller particles offer enhanced conductivity to applications in the electronics and energy storage and transfer areas, such as the example application discussed in the succeeding paragraphs.

As one embodiment of the application of the graphene material produced via the processes described above is a method of producing electrically conductive organic liquids via the suspension of the graphene nanoparticles in organic solvents within specific ranges of concentrations. Current international research is heavily focused on the use of organic liquids (in particular quinones) in flow batteries as high storage capacity alternatives to expensive metal electrolytes. Although these liquids can store large amounts of energy, their usage is hampered by the relatively low conductivity of organic liquids, especially for traditional battery applications. However, the addition of small quantities of graphene, such as the kind produced via the processes described above, to an organic liquid can increase the conductivity (which is equivalent to lowering the resistivity) by up to three orders of magnitude. Furthermore, electrically conducting organic liquid/graphene dispersions offer non-corrosive alternatives to ionic electrolyte solutions and acids, which can be extremely corrosive.

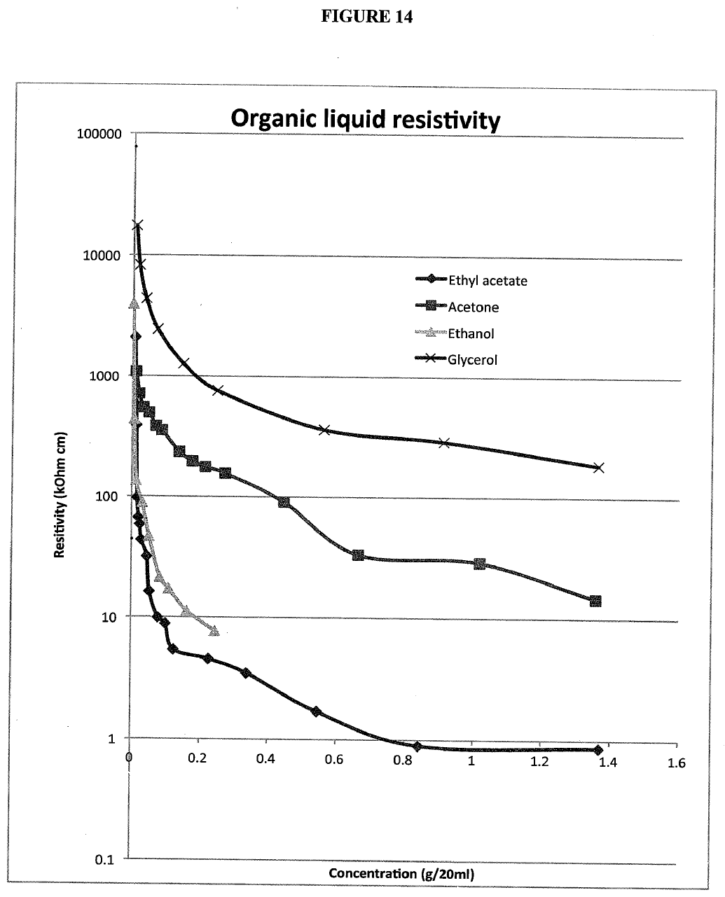

The method of producing electrically conducting organic liquids entails adding incremental amounts of graphene with slow stirring to an organic solvent up to the desired concentration followed by sonication for 1-5 minutes. Subsequent electrical resistance testing reveals drops in resistance of 1-3 orders of magnitude, approaching and sometimes surpassing levels achieved with many inorganic and aqueous-based ionic solutions—see FIG. 14. Relevant concentrations of graphene nanoparticles ranged from 0.01-0.1 g/ml. Graphite mixed in the same organic solvents was also tested for conductivity enhancements, but produced only negligible changes in the liquid conductivities at all concentrations tested.

What is claimed is:

1. A method for making graphene which comprises mixing graphite particles with a liquid medium comprising liquid water and a water-soluble aliphatic solvent to cause formation of a liquid graphitic dispersion in which the liquid medium promotes dispersion of graphite particles therein and conditions graphite particles in the graphitic dispersion to promote delamination thereof, conducting multiple flow streams of the graphitic dispersion along flow streams generally in alignment with an overall flow directional axis of the graphitic dispersion and at relatively high flow velocities through one or more disintegration zones possibly associated with eddy recirculation zones and other associated tortuous paths defined by structure therein so as to cause the flow streams moving through said zones and along said paths to undergo sharply disruptive changes in flow direction so as to induce multiple associated and dissociated vortical flow streams moving at ultra-high Reynolds numbers in excess of 10⁶ and local shear rates in excess of 10⁴ s⁻¹ in order to establish intensely turbulent, ultra-high shear flow conditions and associated ultra-high particle vorticities under which the pre-conditioned graphite particle are subjected to powerfully concentrated, interpenetrating delamination forces, together with high impact, interparticle and other collisions and associated particle comminution to cause conversion of a substantial portion of graphitic particles to graphenic particles in a graphenized liquid dispersion including the liquid medium and a carbonaceous particulate product comprising at least about 80% (dry weight basis) graphene particulates having a single layer or 12 or fewer layers dispersed therein, and treating the graphenized liquid dispersion to separate and recover the carbonaceous particulate product from the liquid medium.

2. The method of claim 1, further comprising recycling liquid medium from the graphenized liquid dispersion for use in providing liquid medium to mix with graphite particles in making graphene.

3. The method of claim 1, wherein radially adjacent disintegration zones are disposed so as to direct flow streams exiting the tortuous paths generally spirally in relation to the overall flow directional axis of the dispersion so as to induce at least some of the resulting vortices to exhibit velocity vectors disposed radially in relation to the overall flow directional axis.

4. The method of claim 1, wherein the method is carried out on a substantially continuous basis and wherein a substantial portion of the supply of the liquid medium is provided by liquid medium from which graphene product has been recovered.

5. The method of claim 1, wherein the liquid medium comprises a mixture of acetone and water.

6. The method of claim 1, wherein the liquid medium is substantially non-toxic and exhibits an ambient temperature surface tension substantially compatible with the surface energy of the graphitic and graphenic particles to promote wetting and conditioning of the graphitic particles by the medium in the graphitic dispersion, to promote transmission of delamination forces onto and into particles undergoing graphenization, and to promote a stable dispersion of the graphenic particles in the graphenic dispersion which reduces any tendency of the graphenic particles to reform into graphitic particles.

7. The method of claim 1, wherein the liquid medium comprises at least about 60% (vol.) substantially non-toxic, aliphatic solvent in solution with and up to about 40% (vol.) water.

8. The method of claim 7, wherein the aliphatic solvent comprises acetone.

9. The method of claim 8, wherein the liquid medium comprises at least about 85% (vol.) acetone and up to about 15% (vol.) water.

10. The method of claim 1, wherein the liquid medium comprises up to about 95% (vol.) aliphatic solvent and from at least about 5% (vol.) up to about 40% (vol.) water.

11. The method of claim 10, wherein the aliphatic solvent comprises acetone.

12. The method of claim 1, wherein the graphite particles comprise from about 0.1 to about 5 wt. % of the graphitic dispersion.

13. The method of claim 12, wherein the graphite particles comprise about 3 wt. % of the graphitic dispersion.

14. The method of claim 1, wherein the carbonaceous particulate product comprises at least about 98% (dry weight basis) graphene particulates having a single to about 15 or fewer layers.

15. The method of claim 1, wherein the layer number distribution and particle size distribution of the graphene product are Poisson distributions, such as those presented in FIGS. 12 A-B and FIGS. 13 A-B.

16. A processes for producing graphene from graphitic material comprising the following steps:
mixing graphitic material at a concentration between 0.25-50.0 g/l in a solution of water and acetone in the range of 10% water/90% acetone to 90% water/10% acetone, with the exact ratio so chosen to match the surface energy of the mixture with that of the graphitic material and/or the produced graphene;
mechanically exfoliating the graphitic material under ultra-high shear into graphene nanoparticle platelets or flakes without the use of oxidizing agents or surfactants, without subjecting the material to high temperatures, and without using sonication or ball milling;
extracting the graphene thus produced from the solvent mixture by filtration or spray drying, without the necessity of prior centrifugation.

17. The processes of claim 16 wherein the surface energy of the solvent mixture of water and a miscible organic liquid is compatible with the surface energy of graphite/graphene to avoid the need for an externally added surfactant and exfoliating material.

18. The processes of claim 16, wherein the mechanical exfoliation step is performed in a batch ultrahigh-shear mixing process or continuously in either the vorticity-shear exfoliator or a Taylor vortex shear exfoliator.

19. The processes of claim 16, wherein the output of the processes is essentially the solvent mixture and graphene nanoparticles and/or flakes.

20. An exfoliator unit for carrying out the process of claim 16.

21. An exfoliator unit according to claim 20, which comprises a turbine impeller with 3-72 blades set at angles ranging from 5-90 degrees with respect to the plane of the impeller.

22. An exfoliator unit according to claim 21, in which the impeller comprises a “turbine impeller.”

23. A graphene nanoflake product made according to the process of claim 16, in which the particle size and layer number distributions correspond substantially to those shown in FIGS. 12 and 13.

24. A method of producing an electrically conductive suspension of graphene particles from graphite particles which comprises providing a mixture of water and an aliphatic organic liquid solvent together with graphite particles mixed therewith, wherein the aliphatic organic liquid solvent is selected from the group consisting of ethanol, ethyl acetate, methanol, glycerol, acetone, propylene glycol, simple ketones, aldehydes, acetates, carboxylic acids, quinones, and mixtures of any two or more thereof, at a graphite particle concentration ranging from about 0.01 to about 0.1 g/ml, and sonicating the mixture for from about one to about five minutes to produce a dispersion of graphenic particles therein comprising at least about 80 wt. % graphenic particles with from about one to about 15 layers and having a width dimension of from about 5 nm to about 5 microns.

25. The electrically conductive suspension of claim 24, wherein the aliphatic organic liquid solvent comprises a solvent selected from the group consisting of acetone, ethanol, ethyl acetate, methanol, glycerol, acetone, propylene glycol, and mixtures of any two or more thereof.
